(19) United States
(12) Patent Application Publication
(10) Pub. No.: US 2007/0038665 A1
(43) Pub. Date: Feb. 15, 2007

(54) LOCAL COMPUTER SEARCH SYSTEM AND METHOD OF USING THE SAME

(75) Inventors: Yong-Jae Kwak, Seoul (KR); Se Jin Cheon, Seoul (KR); Tae Hyeon Park, Gyeonggi-do (KR); Sungwon Kim, Seoul (KR); Jang Won Seo, Seoul (KR); Beom Seok Seo, Seoul (KR)

Correspondence Address: BLACKWELL SANDERS PEPER MARTIN LLP, 720 OLIVE STREET, SUITE 2400, ST. LOUIS, MO, 63101, US

(73) Assignee: NHN CORPORATION, Kyunggi-do (KR)

(21) Appl. No.: 11/464,088

(22) Filed: Aug. 11, 2006

(30) Foreign Application Priority Data
Aug. 12, 2005 (KR) 10-2005-0074294

(51) Int. Cl. G06F 7/00

(52) U.S. Cl. 707/102

(57) ABSTRACT

A local computer search system including: a mini web server installed in the local computer, receiving a search command with respect to data in the local computer from a web browser according to an HTTP protocol and providing a search result in a web document to the web browser; a searcher generating a local computer search result corresponding to an query included in the search command; and a web document generator generating the search result in the web document by converting the local computer search result generated by the searcher into a web document.

### CROSS-REFERENCE TO RELATED APPLICATIONS

This application claims priority from Korean Patent Application No. 10-2005-0074294, filed on Aug. 12, 2005, in the Korean Intellectual Property Office, the disclosure of which is incorporated herein by reference.

### BACKGROUND OF THE INVENTION

1. Field of the Invention

The present invention relates to a search system and method, and more particularly, to a local computer search system and a local computer search method searching for information in a local computer.

2. Description of the Related Art

Due to development of Internet, web search services are generally used to effectively search massive amounts of data on Internet. The web search services automatically traverses a hypertext structure of a web by using a web robot, automatically searches referred documents, and indexes the referenced documents. Users access a web search service site via the Internet and input a keyword, thereby searching for desired information such as web documents, from an indexed database.

As storage space of personal computers, such as desktop and notebook computers, becomes increasingly larger and many files including documents, images, mails, messenger dialogue contents, moving pictures, and music can be stored in the storage space of the desktop or notebook computers, the necessity of searching a local computer, with respect to data in the desktop or notebook, increases in addition to conducting a web search.

For example, when a user of a desktop computer had described his impression about a movie whose title is “island” by using a word processor and wants to find the described impression after several years have passed, the user has to remember exactly which directory a corresponding file is stored and the name of the file to find the described impression of “island” stored within the computer of the user. However, it is often difficult for the user to remember the directory and the file name of all files, such as documents

Even when not precisely remembering which directory a particular file is stored in, when knowing a file name or a character sequence included in the contents of the file, a user may locate a desired file by using a function of searching for a file, provided by an operation system (OS). However, the function of searching for a file, provided by the OS, takes long time due to searching information in a computer of the user in real time. Because of an ever increasing capacity of storage space, such as a hard disk, of a computer, inconvenience gradually increases.

To solve the inconvenience, a desktop search service has been provided. In the desktop search service, when a user inputs a keyword via a deskbar, a toolbar, or a web browser window, information in a computer of the user, associated with the keyword, is searched for. The desktop search helps the users to locate desired information easily by enabling such information in the computer of the user to be searchable and reduces burden of manually arranging files, emails, and bookmarks.

However, in a conventional desktop search service, a desktop search result is generated by intercepting a desktop search command in a web browser by changing or updating a network system file provided by an OS, such as a socket dynamic link library (DLL), and is transmitted to the web browser via the changed network system file.

Accordingly, in the convention desktop search service, when a certain file such as “winsock.dll” is changed or another DLL file associated with the certain file such as “winsock.dll” is changed by the OS or other applications, an error such as a corrupted appearance when accessing a certain website occurs, and operations are unstable. Generally, since the OS or application programs may be frequently updated and the socket DLL or a system DLL on which the conventional desktop search service depends may be changed whenever performing an update, the conventional desktop search service includes a risk of generating an error at any time due to an update of the OS or other applications.

Accordingly, a local computer search system and a local computer search method stably operating by using the hypertext transfer protocol (HTTP) similar to a general website search is seriously required.

Further objectives and advantages of the present invention will become apparent from a careful reading of a detailed description provided hereinbelow, with appropriate reference to accompanying drawings.

### BRIEF SUMMARY OF INVENTION

An aspect of the present invention provides a local computer search system and a local computer search method operating based on a web server to stably operate according to the HTTP protocol similar to a general website search.

An aspect of the present invention also provides a local computer search system and a local computer search method capable of being easily compatible with a general web search system by using the HTTP protocol, and has an interface identical with a general web search service.

An aspect of the present invention also provides a local computer search system and a local computer search method capable of indexing information in a local computer at suitable times by effectively recognizing an idle state of a system by considering various factors in indexing the information in the local computer.

An aspect of the present invention also provides a local computer search system and a local computer search method capable of indexing information associated with newly generated files or newly accessed websites for each occasion by monitoring an event occurrence of a changed or newly generated index object file by monitoring an event occurring due to generating a file change or accessing a website after an initial indexing.

An aspect of the present invention also provides a local computer search system and a local computer search method capable of enabling a local computer personalized for each user to be searched by allowing the user of the local computer to establish a file filter suitably filtering a file by extension for each user's taste.

An aspect of the present invention also provides a local computer search system and a local computer search method capable of stably searching a local computer by properly managing file filters used for indexing information in the local computer.

An aspect of the present invention also provides a local computer search system and a local computer search method capable of efficiently generating a view by including an additional resource component providing a resource required in generating the view provided to a user via a web browser when a language or a font is changed.

An aspect of the present invention also provides a local computer search system and a local computer search method capable of searching a local computer personalized by a user by enabling an extension of a query for each user to be possible.

An aspect of the present invention also provides a local computer search system and a local computer search method capable of receiving a result of searching all computers used by a user when the user uses two or more computers via a local network.

According to an aspect of the present invention, there is provided a local computer search system including: a mini web server installed in the local computer, receiving a search command with respect to data in the local computer from a web browser according to the hypertext transfer protocol (HTTP) protocol and providing, in a web document, a search result to the web browser; a searcher generating a local computer search result corresponding to an query included in the search command; and a web document generator generating the search result in the web document by converting the local computer search result generated by the searcher into the web document.

The system may further include an indexer. The indexer constructs an index database by indexing information in the local computer. The searcher may search the index database by using the query included in the search command and may generate the local computer search result by searching the index database by using the query included in the search command when receiving the search command.

According to an aspect of the present invention, there is provided a method of searching a local computer, including: receiving a search command with respect to data stored in the local computer according to the HTTP protocol, from a web browser in the local computer to a mini web server installed in the local computer; generating a search result in the form a web document by searching for information in the local computer by using a query included in the search command; and providing the search result in the form of the web document to the web browser according to the HTTP protocol via the mini web server.

In this case, the local computer includes all apparatuses including a microprocessor and a storage device, such as a desktop computer, a notebook computer, a laptop computer, a personal digital assistant (PDA), a mobile phone, and an MP3 player. In this case, the storage device may be a hard disk, a RAM, or a ROM and may be a built-in device or external device.

In addition, the local computer may be a concept including a plurality of computers connected via a local-area network (LAN).

In this case, communication between a web browser and a mini web server may be performed by using a loopback interface but may not permit an external access to the mini web server.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram illustrating a local computer search system according to an embodiment of the present invention;

FIG. 2 is a block diagram illustrating an example of an indexer shown in FIG. 1;

FIG. 3 is a block diagram illustrating an example of a searcher shown in FIG. 1;

FIG. 4 is a diagram illustrating index operations of the local computer search system shown in FIG. 1;

FIG. 5 is a diagram illustrating search operations of the local computer search system shown in FIG. 1;

FIG. 6 is a diagram illustrating an example of a view of a result of searching by using the local computer search system shown in FIG. 1;

FIG. 7 is a diagram illustrating another example of the view of the result of searching by using the local computer search system shown in FIG. 1;

FIG. 8 is a flowchart illustrating a local computer search method according to an embodiment of the present invention; and

FIG. 9 is a flowchart illustrating an example of indexing information in a local computer.

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein. Like numbers utilized throughout the various Figures designate like or similar parts.

### DETAILED DESCRIPTION OF THE INVENTION

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the terms “desktop,” “PC,” “local computer,” and the like, refer to computers on which systems (and methods) according to the invention operate. In the illustrated embodiments, these are personal computers, such as portable computers and desktop computers; however, in other embodiments, they may be other types of computing devices (e.g., workstations, mainframes, personal digital assistants or PDAs, music or MP3 players, and the like).

Likewise, the term “document” or “data,” unless otherwise evident from context, refers to digital data files indexed by systems according to the invention. These include by way of non-limiting example word processing files, “pdf” files, music files, picture files, video files, executable files, data files, configuration files, and so forth.

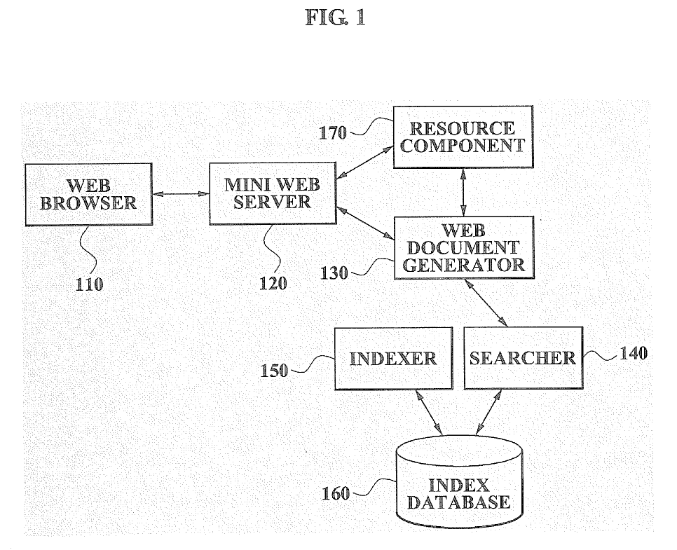

FIG. 1 is a block diagram illustrating a local computer search system according to an embodiment of the present invention. Referring to FIG. 1, the local computer search system according to an embodiment of the present invention includes a web browser 110, a mini web server 120, a web document generator 130, and a searcher 140. As shown in FIG. 1, the local computer search system may further include an indexer 150, an index database 160, and a resource component 170.

The web browser 110 is software enabling various information, taken from a web server while a computer of a user is connected to Internet, to be shown. For example, the web browser 110 may be Internet Explorer of Microsoft Corporation, Netscape Browser of Netscape Communications Corporation, or Firefox of Mozilla Corporation.

The web browser 110 provides an input interface for receiving a search command from a user and displays a search result in the form of a web document to the user.

The input interface may correspond to a general input interface for searching a web. Namely, the web browser 110 enables that the user inputs a keyword in the same way as a method of using a general input interface for searching the web and establishes search objects as a local computer search.

When the user requests a search with respect to data stored in a local computer, the web browser 110 may establish a destination address of the search command to be an address of a local computer in which the web browser 110 is installed, or a loopback address.

The search result in the form of the web document may be a hypertext markup language (HTML) document. In this case, the search result in the form of the web document may be a local computer search result to which a required image or phrase is included. The web browser 110 reads and displays the search result in the form of an HTML document.

The mini web server 120 is a type of a server installed in the local computer, which receives the search command of the user from the web browser 110 by communicating with the web browser 110 according to the HTTP protocol, and provides the search result in the form of a web document to the web browser 110.

In one embodiment the mini web server 120 checks an originating address of the received search command and may be established to provide a service only when the originating address is identical with the address of the local computer in which the mini web server 120 is installed, or the loopback address.

The mini web server 120 accesses the local computer in which the mini web server 120 is installed via a loopback interface and may not permit an external computer to access via Internet.

The web document generator 130 receives the search command from the mini web server 120 and generates the search result in the form of the web document by converting a local computer search result generated by the searcher 140 into the form of a web document.

The web document may be an HTML document as described above. Namely, the web document generator 130 may generate the search result in the form of an HTML document by converting the local computer search result generated by the searcher 140 into the form of an HTML document. Also, the web document generator 130 may generate the web document such as the HTML document by including the required image or phrase in the local computer search result.

Depending upon embodiments, the web document generator 130 may receive a resource required for converting the local computer search result into the form of the web document, from the resource component 170.

The resource component 170 provides the resource required in generating the search result in the form of the web document or a web document resulting from the search result. In this case, the web document in addition to the search result may indicate an index state of the local computer or a guide web document with respect to the local computer search.

The resource component 170 may store all kinds of resources required in generating the web document, such as a character sequence for each language or font.

The searcher 140 receives the search command from the web document generator 130 and generates the local computer search result by searching information in the local computer by using a query included in the search command.

Depending upon embodiments, the searcher 140 may not receive the search command from the web document generator 130 and may directly receive the search command from the mini web server 120.

The indexer 150 constructs the index database 160 by indexing the information in the local computer.

When receiving the search command, the searcher 140 may generate the local computer search result by searching the index database 160 by using the query included in the search command.

As described by referring to FIG. 1, the web browser 110 communicates with the mini web server 120 according to a client/server protocol such as HTTP by including the mini web server 120, thereby constructing the local computer search system stably operating similar to a general web search system. In addition, when the user uses two or more computers, since the local computer search system according to an embodiment of the present invention operates based on the web server, search results collected from a mini web server included in each of computers may be easily collated, thereby efficiently performing the local computer search.

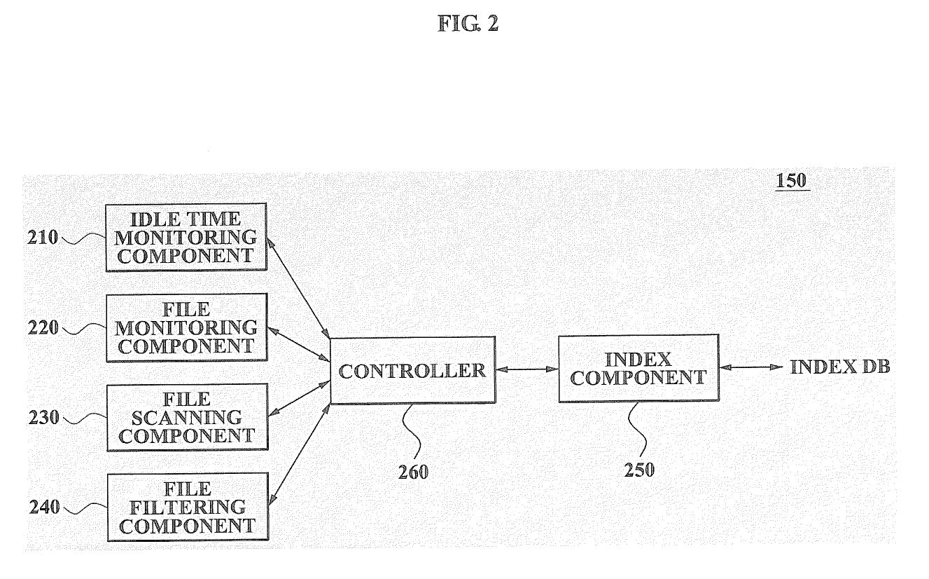

FIG. 2 is a block diagram illustrating an example of the indexer 150 shown in FIG. 1. Referring to FIG. 2, the indexer 150 includes an idle time monitoring component 210, a file monitoring component 220, a file scanning component 230, a file filtering component 240, an index component 250, and a controller 260.

The idle time monitoring component 210 monitors an idle time of the local computer. In this case, the idle time indicates a time when a rate of using or occupying the local computer by the user or other applications is less than a predetermined level. Namely, since the idle time is a time when the local computer is not used for other work, the idle time may be a time capable of being used for index operations for the local computer search.

In one embodiment, whether it is the idle time may be determined by considering a central processing unit (CPU) utilization rate, a memory utilization rate, whether an input component operates, and/or a drive utilization rate. Specifically, when the utilization rates of the CPU and memory are less than percentages respectively established, an input of the user with respect to the input component such as a keyboard and a mouse does not occur, and data input/output via a hard disk, or network traffic is less than a predetermined level, it may be determined to be the idle time.

In further embodiment, the local computer system may start index operations with respect to the local computer only when the idle time is maintained for a predetermined period of time. For example, when a time determined to be the idle time by satisfying predetermined conditions is maintained for more than 15 seconds, the local computer search system may perform the index operations with respect to the local computer.

The file monitoring component 220 monitors any changes made to an index object file in the local computer. The event occurring in the index object file may include events which the index object file is generated, changed or updated. The index object file may be a document file, an audio file, a video file, an image file, a messenger dialogue content file, an email, and the like stored in the local computer. For example, when a word document whose extension is “hwp” or “doe” is changed and newly stored, any changes are made which may be monitored by the file monitoring component 220.

In addition, the changes may be made when information with respect to a website accessed by the user is updated. For example, when the user accesses a new website, not accessed by the user before, via Internet, a URL, a title of the website, an HTML source, and a snapshot resulting in a thumbnail image of a browser displaying the accessed website are newly stored in the local computer and the changes are made.

The file scanning component 230 scans the index object files from the files stored in the local computer. In this case, the index object files may include the document file, the audio file, the video file, the image file, the messenger dialogue content file, and the email. Accordingly, a part of the index object files having a certain extension in the information from the local computer may be objects of the index for the local computer search.

The file filtering component 240 generates index information by filtering the index object files for each extension. For example, the file filtering component 240 may generate the index information by extracting text data from one of a file name, an extension, a path name, capacity information, date, and a part of the contents of a document file, an email and messenger dialogue content having an extension such as “hwp” and “doc”. In this case, the index information extracted from the document content may be extracted from a front part or a rear part of the document content, or a part may be extracted from both the front part and the rear part. In addition, the index information extracted from the document file may include the entire contents of the document.

In one embodiment, with respect to an image file having an extension such as “jpg”, “gif”, “bmp” or “tif”, the file filtering component 240 may generate the index information by extracting the file name, the extension, the path name, the capacity information, and the date, and generating the thumbnail.

In another embodiment, with respect to an audio file having an extension such as “mp3”, “wav”, “ra”, and “aac”, the file filtering component 240 may generate the index information by extracting the file name, the extension, the path name, the capacity information, the date, and tag information.

In further embodiment, with respect to a video file having an extension such as “avi” “mov”, “mpeg”, “dat”, “as”, “vob”, and “m2v”, the file filtering component 240 may generate the index information by extracting the file name, the extension, the path name, the capacity information, the date, and the tag information and generating a snapshot.

The tag information may include information associated with media playback, such as a playtime, a channel, an audio sampling speed, and a bit transmission rate, and additional meta-information such as an author, a year, a genre, and/or an album.

The index component 250 extracts an index term by using the index information and constructs the index database 160 shown in FIG. 1.

The controller 260 controls the file scanning component 230, the file filter 240, and the index component 250 to index the information in the local computer when the idle time is maintained for more than a certain period of time. In one embodiment, the controller 260 controls to index the information in the local computer when the idle time is maintained for more than 15 seconds.

Since there is no collated index information in the index database immediately after a program for the local computer search is installed in the local computer, initial index operations with respect to collection object files in the local computer are performed for each idle time of the local computer. The initial index operations may be performed once at the beginning of installation of the program for the local computer search and a resource indicating a progress of the initial index operations may be generated by the resource component 170 shown in FIG. 1 and may be provided to the web browser 110 via the mini web server 120 to be displayed to the user.

The controller 260 may perform real-time index operations to collect indexes with respect to a corresponding file or website by sensing an event occurring whenever generating/changing a file or visiting a website, after the initial index operations are completed. Accordingly, the index of the local computer may be efficiently collected by collecting index with respect to the changed or newly generated index object files after the initial index operations are completed, for each occurrence of a changed or newly generated index object file.

Not shown in FIG. 2, the indexer 150 shown in FIG. 1 may further include a filter management component exchanging a file filter with respect to a certain extension in the file filtering component 240 and registering a new file filter with respect to an extension whose file filter is not registered, in the file filtering component 240. When the new file filter with respect to the extension whose file filter is not registered is registered, the filter management component provides newly added extension information to the file scanning component 230 and the file monitoring component 220 to be included in the index object files.

In this case, the filter management component enables the user of the local computer to establish a file filter suitable for the local computer. Accordingly, the user may directly generate a file filter corresponding to a certain extension or may change a previously established file filter. In addition, with respect to an extension that is not a search object and is not indexed, the user may directly register the extension as the index object file or may register a file filter used for the file by using the filter management component. Accordingly, the local computer search personalized according to a property of the local computer of the user is possible.

Also, the filter management component may omit the file filtering when the file filter with respect to the certain extension cannot complete filtering within a predetermined time, and may delete a certain file filter after a number of times of when filtering cannot be completed, with respect to the certain file filter, is checked and the number of times is more than a predetermined value.

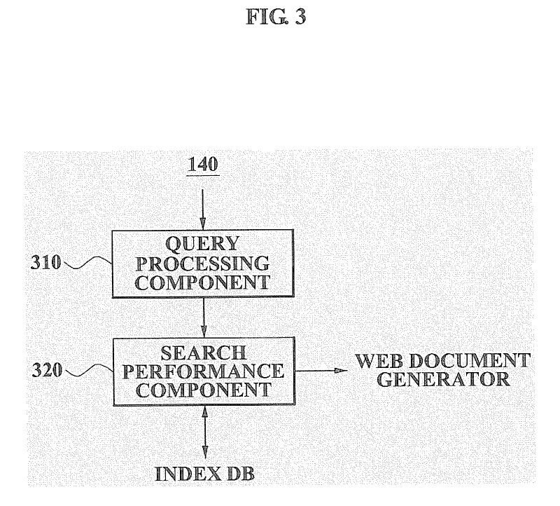

FIG. 3 is a block diagram illustrating an example of the searcher 140 shown in FIG. 1. Referring to FIG. 3, the searcher 140 includes a query processing component 310 and a search performance component 320.

When there is a keyword registered by the user in the query included in the search command, the query processing component 310 extends the query corresponding to the keyword. In this case, the query extension replaces a certain keyword by a registered query set or a registered search condition. In this case, the query set may be one keyword or two or more keywords bound by an OR operator. In this case, the search condition may be the index object file or a search object period of the index object file.

For example, with respect to a keyword such as “NHN” from queries used for searching the information in the computer of the user, the user may register a query set such as “Naver+Hangame+Archlord”. Also, with respect to a keyword such as “stocks”, the user may register a query set such as “Korean Composite Stock Price Index+stock price of Samsung Electronics+stock price of Hyundai Motor Company”. In this case, “+” indicates the OR operator. In one embodiment, when the user gives the search command including the keyword such as “NHN” to search the computer of the user, the query processing component 310 may replace the keyword such as “NHN” from queries included in the search command with “Naver+Hangame+Archlord”. Also, when the user gives the search command including the keyword such as “stocks” to search the computer of the user, the query processing component 310 replaces the keyword such as “stocks” from queries included in the search command by “Korean Composite Stock Price Index+stock price of Samsung Electronics+stock price of Hyundai Motor Company”.

In one embodiment, the user may register and maintain a “jpg” extension and a “gif” extension with respect to a keyword such as “photograph” from queries used for searching the information in the computer of the user, as the search condition. When the user gives the search command including the keyword such as “Madonna photographs” to search the computer of the user, the query processing component 310 may replace the keyword such as “Madonna photographs” from queries included in the search command by the search condition on the “jpg” extension and the “gif” extension to perform search on files having the “jpg” extension and the “gif” extension by using a keyword such as “Madonna”.

For example, the user may register “Jun. 27, 2005-Jul. 4, 2005” as the search condition with respect to a keyword such as “vacation 2005” from the queries used for searching the computer of the user. When the user gives the search command including the keyword such as “vacation 2005, Hong Kong” to search the computer of the user, the query processing component 310 may replace the keyword such as “vacation 2005” from queries included in the search command by the search condition on files generated or changed within “Jun. 27, 2005-Jul. 4, 2005” to perform a search on the files generated or changed within “Jun. 27, 2005-Jul. 4, 2005” by using a keyword such as “Hong Kong”.

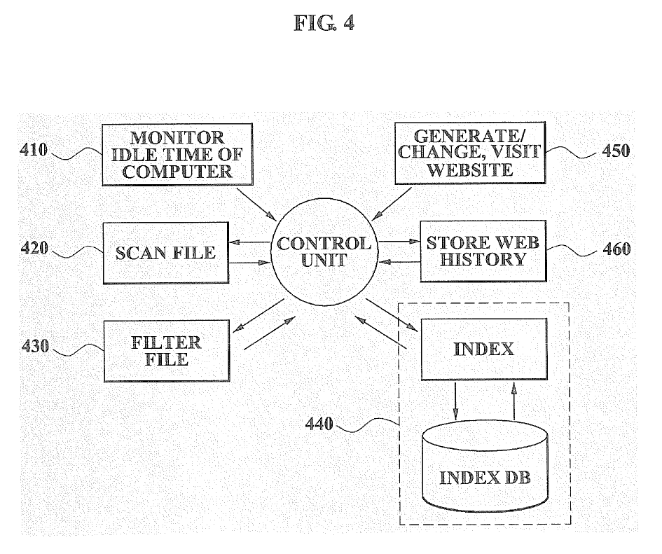

FIG. 4 is a diagram illustrating the index operations of the local computer search system shown in FIG. 1. Referring to FIG. 4, the local computer system monitors an idle time of a local computer for initial index operations (410).

A controller starts the initial index operations of the local computer when the idle time is maintained for a predetermined period of time as a result of monitoring the idle time.

When the initial index operations are started, files stored in the local computer are scanned (420). In this case, file scanning indicates searching for an index object file as described above.

When the index object file is located by scanning the files, the located index object file is filtered (430).

When index information is generated by filtering the index object file, an index database is constructed by extracting an index term using the index information (440).

The index object file may be generated/changed or a user may visit a certain website via Internet, during or after the initial index operations (450). In this case, by sensing an event of the index object file being generated/changed occurring when the user visits the certain website, the controller may perform real-time index operations.

A predetermined event may occur when the index object file is generated/changed or the user visits the certain website, the local computer search system may perform file filtering with respect to the generated/changed file or a URL, a title, an HTML source, and a snapshot resulting in a thumbnail image of a browser displaying the visited website when sensing the visit (430) and may construct the index database by extracting the index term (440).

In one embodiment, instead of indexing a website history by sensing the event occurring when the user visits the website, the local computer search system may just store the URL, the title, the HTML source, and a snapshot resulting in the thumbnail image of a browser displaying the visited website when the user visits the website (460) and may perform the index operations by accessing the stored data at a certain interval of time.

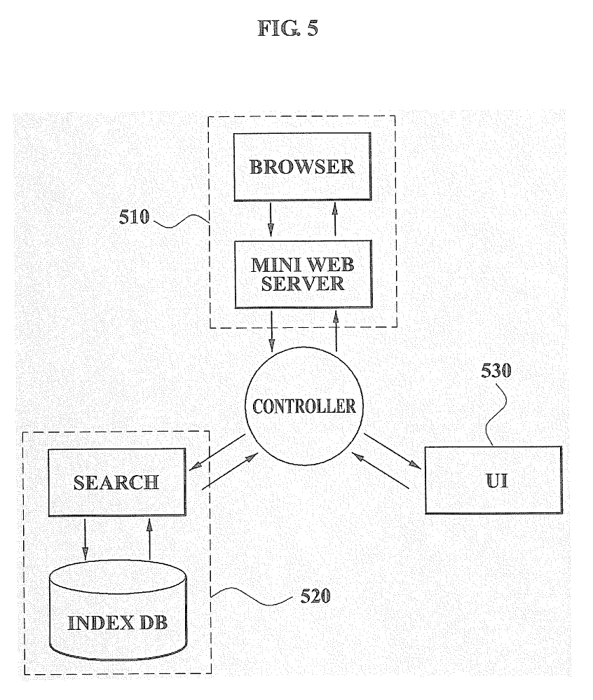

FIG. 5 is a diagram illustrating search operations of the local computer search system shown in FIG. 1.

Referring to FIG. 5, in the local computer search system, a search command of a user and a search result in the form of a web document are transmitted and received between a web browser and a mini web server by using the HTTP protocol (510).

Communication between the web browser and the mini web server may be performed similar to a general web search by using the mini web server, thereby easily interchanging with a general web search system and stably constructing the local computer search system.

When the search command of the user is transmitted via the web browser and the mini web server, the local computer search system generates a local computer search result by searching an index database using a query included in the search command (520).

When the local computer search result is generated, the local computer search system generates a web document such as an HTML document provided to the user by including required resources such as an image or a phrase (530).

A controller shown in FIG. 5 is separated just for convenience of describing the operations of the local computer search system and is not corresponding to the element of the local computer search system shown in FIG. 1 or 2.

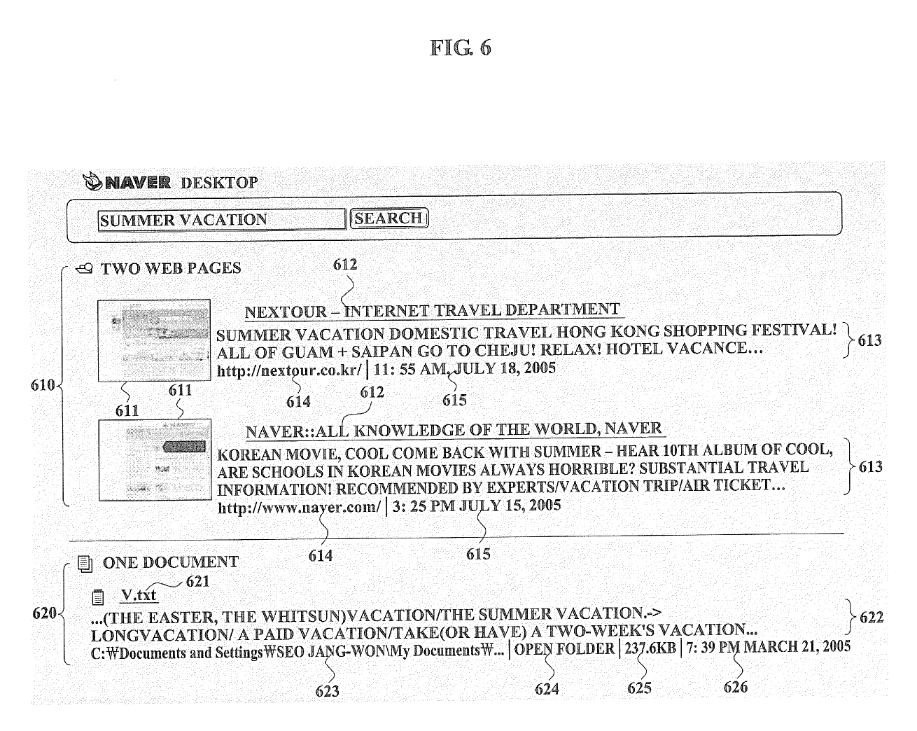

FIG. 6 is a diagram illustrating an example of a view of a result of searching by using the local computer search system shown in FIG. 1.

Referring to FIG. 6, it may be known that there are two located web page search results 610 and one document search result 620 as a result of searching a local computer by using “summer vacation” as a query.

In the web page search result 610, a thumbnail image 611 of a website visited by a user of the local computer, a website title 612, contents associated with the query 613 from website contents, a URL 614, and date/time 615 are displayed. When one of the thumbnail image 611, the website title 612, and the URL 614 is clicked, a present web browser window may be directly linked to a corresponding website or the corresponding website may be linked by opening a new window.

In one embodiment, the thumbnail image 611, the website title 612, the content associated with the query 613, the URL 614, and the date/time 615 may be data stored in an index database generated by indexing information in the local computer.

In the document search result 620, a file name 621 including an extension of a document file in the local computer, content associated with the query 622 from file contents, a path name 623 of a corresponding file, a folder open link 624, capacity information 625, and date/time 626 are displayed. When the file name 621 including the extension is clicked, the corresponding file may be directly opened in the present web browser window or may be opened by executing an application such as a corresponding word processor. When the folder open link 624 is clicked, a folder including the corresponding document file may be opened in the present web browser window or may be opened by opening a new window.

In one embodiment, the file name 621 including the extension, the content associated with the query 622, the path name 623, the folder open link 624, the capacity information 625, and the date/time 626 may be the data stored in the index database generated by indexing the information in the local computer.

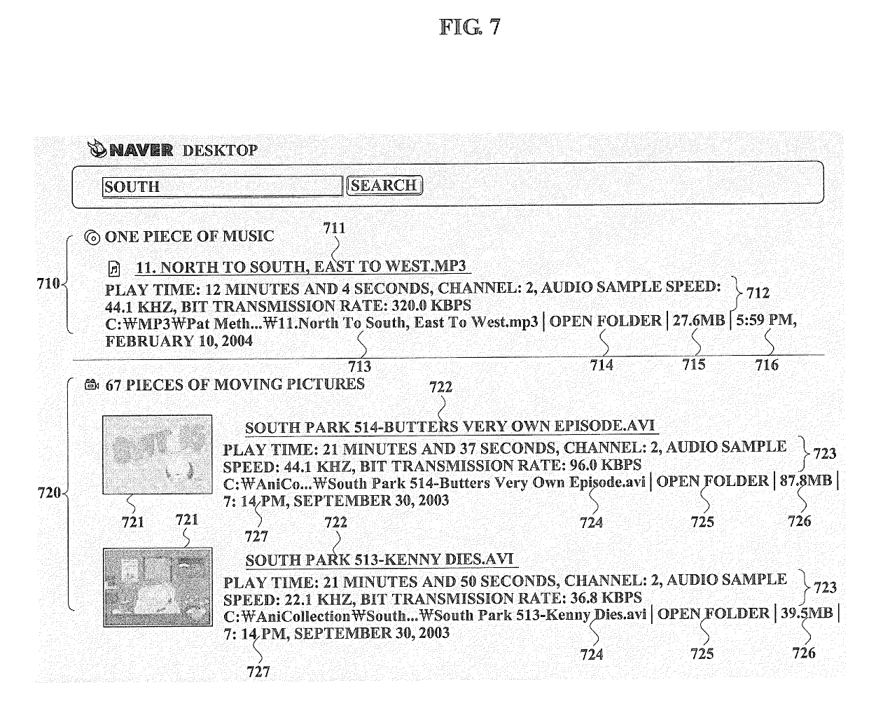

FIG. 7 is a diagram illustrating another example of the view of the result of searching by using the local computer search system shown in FIG. 1.

Referring to FIG. 7, it may be known that there is one music search result 710 located and a plurality of moving picture search results 720 as a result of searching a local computer by using “south” as a query.

In the music search result 710, a file name 711 including an extension of an audio file in the local computer, tag information 712, a path name 713 of a corresponding file, a folder open link 714, capacity information 715, and date/time 716 are displayed. In this case, when the file name 711 including the extension is clicked, the corresponding audio file may directly replay by operating an application for replaying the corresponding audio file. Also, when the folder open link 714 is clicked, a folder including the corresponding audio file may be opened in a present web browser window or may be opened by opening a new window.

The file name 711 including the extension, the tag information 712, the path name 713 of the corresponding file, the folder open link 714, the capacity information 715, and the date/time 716 may be data stored in the index database generated by the information in the local computer.

In the moving picture search result 720, a snapshot 721, a file name 722 including an extension of a video file in the local computer, tag information 722, a path name 724 of a corresponding file, a folder open link 725, capacity information 726, and date/time 727 are displayed. In this case, when the file name 722 including the extension is clicked, the corresponding video file may be directly replayed by operating an application for replaying the corresponding video file. Also, when the folder open link 725 is clicked, a folder including the corresponding video file may be directly opened in the present web browser window or may be opened by opening a new window.

In one embodiment, the snapshot 721, the file name 722 including the extension, the tag information 722, the path name 724 of the corresponding file, the folder open link 725, the capacity information 726, and the date/time 727 are the data stored in the index database generated by indexing the information in the local computer.

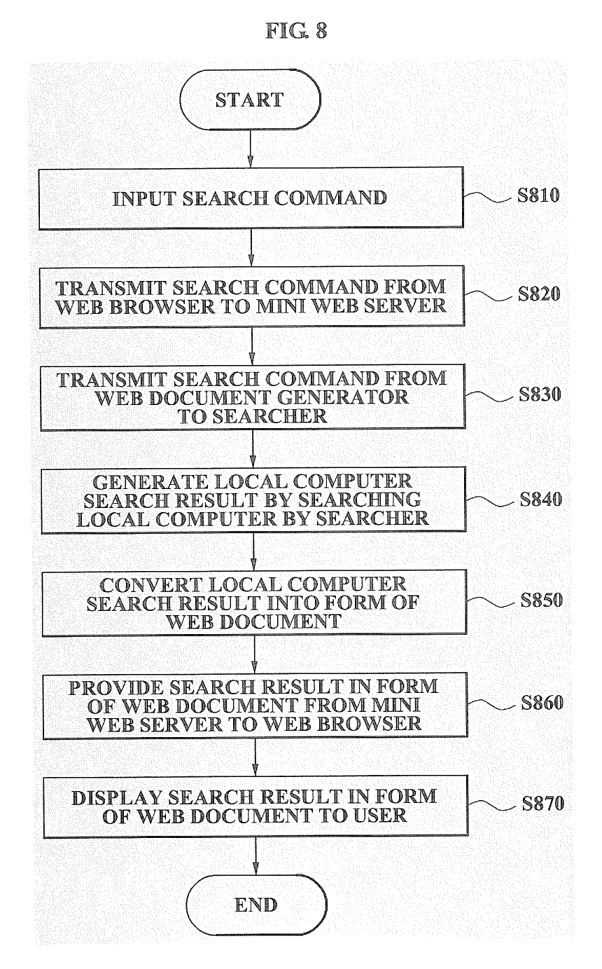

FIG. 8 is a flowchart illustrating a local computer search method according to an embodiment of the present invention.

Referring to FIG. 8, a web browser provides an input interface for receiving a search command from a user, thereby receiving the search command of the user (S810).

When the search command of the user is a local computer search command, a mini web server installed in a local computer receives the search command of the user from the web browser according to an HTTP protocol (S820).

When the user requests local computer search in the web browser, the local computer search method may further include establishing a destination address of the search command as an address of the local computer in which the web browser is installed, or a loopback address. In one embodiment, the mini web server may check an originating address of the received search command and may provide a service only when the originating address is identical with the address of the local computer in which the mini web server is installed, or the loopback address.

A web document generator receives the search command from the mini web server and transmits the search command to a searcher (S830).

In the embodiment described by referring to FIG. 8, even though the web document generator transmits the search command from the mini web server to the searcher, the search command may be directly transmitted from the mini web server to the searcher without passing through the web document generator.

The searcher searches information in the local computer by using a query included in the transmitted search command and generates a local computer search result (S840).

In this case, when there is a keyword registered by the user in the queries included in the search command, the generating the local computer search result may include extending the query corresponding to the keyword and searching the information in the local computer by using the extended query.

The web document generator converts the local computer search result into the form of a web document to generate a search result in the form of the web document (S850).

In this case, the web document may be an HTML document. In this case, the search result in the form of the web document may be the local computer search result including a required resource such as an image or a phrase.

The mini web server provides the search result in the form of the web document to the web browser according to the HTTP protocol (S860).

The web browser displays the search result in the form of the web document to the user (S870).

Not shown in FIG. 8, the local computer search method according to an embodiment of the present invention may further include constructing an index database by indexing the information in the local computer. In this case, in the generating the local computer search result (S840), when the search result is received, the local computer search results may be generated by searching the index database by using the query included in the search result.

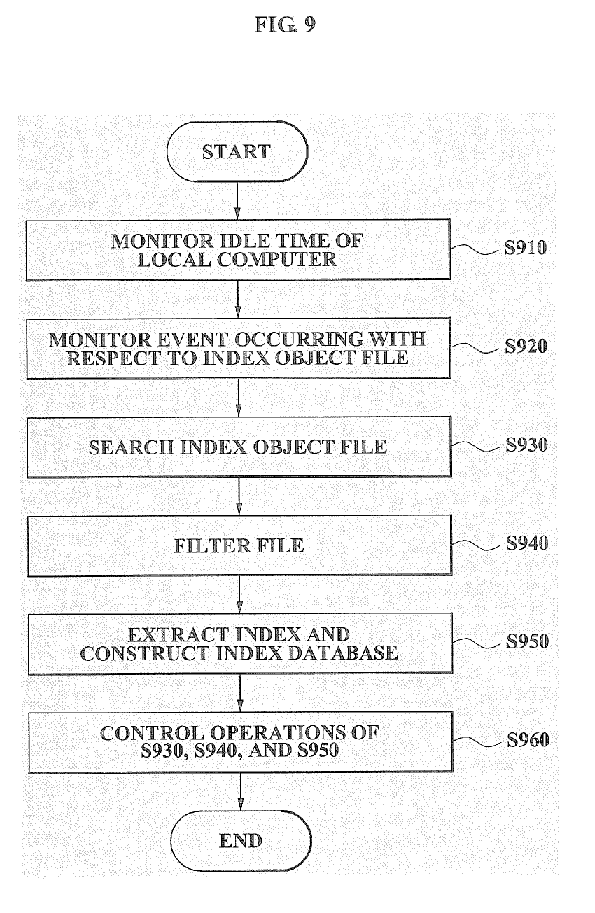

FIG. 9 is a flowchart illustrating an example of indexing information in a local computer.

Referring to FIG. 9, an idle time of the local computer is monitored (S910).

An event occurring in a search object file in the local computer is monitored (S920).

Index object files are searched from files stored in the local computer (S930).

The index object files are filtered for each extension to generate index information (S940).

An index term is extracted by using the index information and the index database is constructed (S950).

The searching for the index object files according to a result of monitoring the idle time and the event (S930), the filtering the index object files (S940), and the extracting the index term and constructing the index database (S950) are controlled (S960).

In this case, in operation S960, when the event occurs in the index object file in the local computer, operations S940 and S950 may be controlled to index the index object file in which the event occurs.

In operation S960, when the idle time of the local computer is maintained for more than a certain period of time, operations S930, S940, and S950 may be controlled to index files stored in the local computer and not indexed.

Each operation shown in FIG. 9 may be performed in the order shown in FIG. 9, in a reverse order, or all at the same time.

Since the method described by referring to FIGS. 8 and 9 may be applied as it is to the previous embodiments associated with the local computer system, hereinafter, the description will be omitted.

The local computer search method according to the present invention may be embodied as a program instruction capable of being executed via various computer components and may be recorded in a computer-readable recording medium. The computer-readable medium may include a program instruction, a data file, and a data structure, separately or cooperatively. The program instructions and the media may be those specially designed and constructed for the purposes of the present invention, or they may be of the kind well-known and available to those skilled in the art of computer software arts. Examples of the computer-readable media include magnetic media (e.g., hard disks, floppy disks, and magnetic tapes), optical media (e.g., CD-ROMs or DVD), magneto-optical media (e.g., optical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level language codes that may be executed by the computer using an interpreter. The hardware elements above may be configured to act as one or more software modules for implementing the operations of this invention.

An aspect of the present invention provides a local computer search system and a local computer search method operating based on a web server to stably operate according to the HTTP protocol similar to a general website search.

An aspect of the present invention also provides a local computer search system and a local computer search method capable of being easily compatible with a general web search system by using the HTTP protocol, and has an interface identical with a general web search service.

An aspect of the present invention also provides a local computer search system and a local computer search method capable of indexing information in a local computer at suitable times by effectively recognizing an idle state of a system by considering various factors in indexing the information in the local computer.

An aspect of the present invention also provides a local computer search system and a local computer search method capable of indexing information associated with newly generated files or newly accessed websites for each occurrence of a changed or newly generated index object file by monitoring an event occurring due to generating a file change or accessing a website after an initial indexing.

An aspect of the present invention also provides a local computer search system and a local computer search method capable of enabling a local computer personalized for each user to be searched by allowing the user of the local computer to establish a file filter suitably filtering a file by extension for each user's taste.

An aspect of the present invention also provides a local computer search system and a local computer search method capable of stably searching a local computer by properly managing file filters used for indexing information in the local computer.

An aspect of the present invention also provides a local computer search system and a local computer search method capable of efficiently generating a view by including an additional resource component providing a resource required in generating the view provided to a user via a web browser when a language or a font is changed.

An aspect of the present invention also provides a local computer search system and a local computer search method capable of searching a local computer personalized by a user by enabling an extension of a query for each user to be possible.

An aspect of the present invention also provides a local computer search system and a local computer search method capable of receiving a result of searching all computers used by a user when the user uses two or more computers via a local network.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A local computer search system comprising:
a web browser, the web browser providing an input interface, the web browser displaying a search result in the form of a web document;
a mini web server installed in the local computer, the mini web server receiving a search command with respect to data in the local computer from the web browser according to the hypertext transfer protocol (HTTP) protocol and providing the search result to the web browser in the form of the web document;
a searcher, the searcher generating a local computer search result corresponding to an query included in the search command; and
a web document generator, the web document generator generating the search result in the form of the web document by converting the local computer search result generated by the searcher into the web document.

2. The system of claim 1, wherein, when a user requests to search the local computer in the web browser, a destination address of the search command is established to be an address of the local computer, or a loopback address.

3. The system of claim 1, wherein the mini web server checks an originating address of the received search command and provides a service only when the originating address is identical with an address of the local computer including the mini web server, or a loopback address.

4. The system of claim 1, further comprising an indexer, the indexer constructing an index database by indexing information in the local computer,
wherein the searcher searches the index database by using the query included in the search command and generates the local computer search result.

5. The system of claim 4, wherein, when any changes are made to an index object file in the local computer, the indexer indexes the index object file in which the changes are made.

6. The system of claim 5, wherein the changes are made when the index object file is newly generated, changed or updated.

7. The system of claim 5, wherein the indexer comprises:
a file monitoring component, the file monitoring component monitoring the changes made to the index object file in the local computer; and
an index component, the index component constructing the index database by using index information associated with the index object file.

8. The system of claim 7, wherein the indexer further comprises a file filtering component, the file filtering component generating the index information by filtering the index object file for each extension, and the index component extracts an index term by using the index information generated by the file filtering component and constructs the index database.

9. The system of claim 8, wherein the file filtering component performs the operations of:
extracting a file name, an extension, a path name, capacity information, a date, and a part of contents of a file in the form of text, with respect to an email document file;
extracting a file name, an extension, a path name, capacity information, and a date, and generating a thumbnail, with respect to an image file;
extracting a file name, an extension, a path name, capacity information, a date, and tag information, with respect to an audio file; and
extracting a file name, an extension, a path name, capacity information, a date, and tag information, and generating a snap shot, with respect to a video file.

10. The system of claim 7, wherein:
the indexer further comprises a file scanning component scanning the index object files from the files stored in the local computer; and
the index component constructs the index database by using the index information of the index object file.

11. The system of claim 10, wherein:
the indexer further comprises an idle time monitoring component, the idle time monitoring component monitoring an idle time of the local computer; and
the index component indexes the files stored in the local computer, which have been not indexed, when the idle time of the local computer is maintained for more than a predetermined period of time.

12. The system of claim 11, wherein the idle time monitoring component determines whether the local computer is idle by considering a utilization rate of a central processing component, a utilization rate of a memory, whether an input component operates, and a utilization rate of a drive.

13. The system of claim 11, wherein the indexer indexes the files stored in the local computer before the local computer search system is installed, when the idle time is maintained for more than the predetermined period of time.

14. The system of claim 4, wherein the indexer comprises:
a file scanning component, the file scanning component scanning index object files from files stored in the local computer; and
an index component, the index component constructing an index database by using index information of the index object file, when an idle time of the local computer is maintained for more than a predetermined period of time.

15. The system of claim 14, wherein:
the indexer further comprises an idle time monitoring component monitoring the idle time of the local computer, and the index component constructs the index database by using the index information of the index object file, when the idle time of the local computer is maintained for more than the certain period of time.

16. The system of claim 14, wherein:
the indexer further comprises a file filtering component, the file filtering component generating the index information by filtering the index object file for each extension; and
the index component extracts an index term by using the index information generated by the file filtering component and constructs the index database.

17. The system of claim 16, wherein the file filtering component performs the operations of:
extracting a file name, an extension, a path name, capacity information, a date, and a part of contents of a file in the form of text, with respect to a word processor file and an email document file;
extracting a file name, an extension, a path name, capacity information, and a date, and generating a thumbnail, with respect to an image file;
extracting a file name, an extension, a path name, capacity information, a date, and tag information, with respect to an audio file; and
extracting a file name, an extension, a path name, capacity information, a date, and tag information, and generating a snap shot, with respect to a video file.

18. The system of claim 4, wherein:
the indexer further comprises a filter management component, the filter management component changing a file filter with respect to a certain extension in the file filtering component, or registering a new file filter with respect to an extension whose file filter is not registered,
the filter management component omitting file filtering when the file filter with respect to the certain extension cannot complete file filtering for a predetermined period of time and deletes the corresponding file filter when a number of failing to complete the filtering is more than a predetermined value.

19. The system of claim of 1, further comprising a resource component, the resource component providing resource required in generating a web document displayed to the user via the web browser,
the resource component providing a resource required when the web document generator generates the search result in the form of the web document.

20. The system of claim 1, wherein the searcher comprises:
a query processing component, the query processing component extending a query corresponding to a keyword registered by the user, when the keyword is included in the query included in the search command; and
a search performance component, the search performance component searching for the information in the local computer by using the query processed by the query processing component.

21. The system of claim 20, wherein the query processing component replaces a certain keyword by a registered query set or registered search condition.

22. A method of searching a local computer, comprising:
transmitting a search command with respect to data stored in the local computer according to the HTTP protocol, from a web browser to a mini web server installed in the local computer;
receiving the search command from the web browser;
generating a search result in the form a web document by searching for information in the local computer by using a query included in the search command; and
providing the search result in the form of the web document to the web browser according to the HTTP protocol via the mini web server.

23. The method of claim 22, further comprising establishing a destination address of the search command as the local computer in which the web browser is installed, or a loopback address, when a user requests local computer search in the web browser.

24. The method of claim 22, wherein the mini web server checks an originating address of the received search command and provides a service only when the originating address is identical with the local computer including the mini web server, or the loopback address.

25. The method of claim 22, further comprising constructing an index database by indexing the information in the local computer,
wherein, in the generating a search result in the form a web document, the local computer search result is generated in the form the web document by searching the index database using the query included in the search command.

26. The method of claim 25, wherein, in the constructing an index database, when any changes are made to an index object file in the local computer, the index object file in which the changes are made is indexed.

27. The method of claim 25, wherein, the step of constructing an index database further comprises:
monitoring an idle time of the local computer; and
indexing files stored in the local computer, which have been not indexed when the idle time of the local computer is maintained for more than a predetermined period of time.

28. The method of claim 22, wherein the generating a search result in the form a web document comprises:
extending a query corresponding to a keyword registered by the user when the keyword is included in the query included in the search result; and
searching the information in the local computer by using the extended query.

29. A computer-readable recording medium in which a program for executing a method of searching a local computer is recorded, the method comprising:
transmitting a search command with respect to data stored in the local computer according to the HTTP protocol, from a web browser to a mini web server installed in the local computer;
receiving the search command from the web browser;
generating a search result in the form a web document by searching for information in the local computer using a query included in the search command; and
providing the search result in the form of the web document to the web browser according to the HTTP protocol via the mini web server.
